(19) United States
(12) Patent Application Publication
(10) Pub. No.: US 2015/0336304 A1
(43) Pub. Date: Nov. 26, 2015

(54) MOLD FOR FORMING A MOTOR VEHICLE PART FROM A POLYMER MATERIAL

(71) Applicants: Patrick Bosg, Saint Barthelemy De Vals (FR); Jean-Yves Sozet, Vion (FR); Paul Brialon, Annonay (FR); Arnaud Bosc, Saint Peray (FR)

(72) Inventors: Patrick Bosg, Saint Barthelemy De Vals (FR); Jean-Yves Sozet, Vion (FR); Paul Brialon, Annonay (FR); Arnaud Bosc, Saint Peray (FR)

(73) Assignee: Compagnie Plastic Omnium, Lyon (FR)

(21) Appl. No.: 14/410,445

(22) PCT Filed: Jul. 6, 2012
(86) PCT No.: PCT/FR2012/051609

§ 371 Date: Jul. 30, 2015

(51) Int. Cl. B29C 43/18

(52) U.S. Cl. CPC B29C 43/18; B29K 2069/00

(57) ABSTRACT

A mold for forming a motor vehicle part from a polymer material comprising at least one partially overmolded metal insert having a portion intended to be covered with polymer material and a portion intended to be left uncovered. The insert comprises an overmolding limit and the mold comprises a die and a punch capable of taking different positions between:
an open position for introduction of inserts and polymer material in the mold, and
a molding position wherein the mold cavity is closed,
the mold comprising holding means and blocking area
at least one movable part
and at least one projection extending over a sealing area completely including the insert overmolding limit, to prevent the polymer material from crossing the sealing area seeping between the part of the insert intended to not be covered and one of the opposite faces of the holding means and of the blocking area.

### CROSS-REFERENCE TO RELATED APPLICATIONS

This application is the U.S. National Phase application of PCT/FR2012/051609 filed Jul. 6, 2012, which application is incorporated herein by reference and made a part hereof.

### BACKGROUND OF THE INVENTION

1. Field of the Invention

This invention relates to the technical field of plastic floors for motor vehicles.

2. Description of the Related Art

The manufacture of a motor vehicle starts by a step of metalworking, which consists in producing a body in white, by welding together various metal parts, body which is then immersed in a cataphoresis bath to treat the surfaces of the metal parts and the spot welds against corrosion.

After the cataphoresis stage, the body undergoes various assembly and painting steps until a complete vehicle is obtained.

It is known that the use of plastic parts in the constitution of a vehicle is a success factor in the search to reduce fuel consumption, thanks to the weight reduction obtained by replacing a metal part by a lighter plastic part.

However, the existence of already operational assembly lines organized in the order indicated above, namely first metalworking and cataphoresis, followed by painting and assembly, makes it difficult, even financially impossible, to develop manufacturing processes in which this order is not respected.

It is therefore to comply with the existing assembly lines that the manufacture of plastic parts with metal inserts to be welded to other metal parts during the metalworking step has already been proposed. In particular, document FR2915129 discloses a motor vehicle floor having inserts partially overmolded in a layer of AMC (Advanced Molding Compound), BMC (Bulk Molding Compound) or SCM (Sheet Molding Compound), a thermosetting material particularly suited to this application due to its mechanical strength and its ability to undergo the cataphoresis step without degrading. The inserts comprise areas not covered by the plastic material, on which welding can be carried out, in order to assemble the floor with other metal parts during the metalworking.

One of the difficulties which arise during the manufacture of thermosetting plastic parts fitted with overmolded welding inserts is that overmolding is inevitably accompanied by burrs, which must be removed once the part is taken out of the mold in order to avoid any adverse consequences later. In particular, the adverse consequences of failure to deburr are, without this list being exhaustive:

risk of polluting the cataphoresis bath if the burrs detach during this step;

poor cataphoresis treatment efficiency due to partial masking of the surface of the metal part to be treated and risk of corrosion if the burrs detach later;

risk of imperfect welds due to partial coverage of the weld zone by the electrically insulating plastic.

But deburring itself involves certain difficulties. Since the burrs are present on the exposed metal surfaces of the inserts, removing burrs by chemical or mechanical action such as cutting, water jet or blowing may damage the metal surface and prepare conditions for early corrosion of the metal or the weld.

There is therefore a need for a solution to mold thermosetting plastic parts in which the removal of burrs does not generate these difficulties.

### SUMMARY OF THE INVENTION

The invention aims to remedy these disadvantages by providing a mold for forming a motor vehicle part from a polymer material comprising at least a partially overmolded metal insert, in other words having a portion to be covered with polymer material and a portion to be left uncovered, the limit between these two portions being a line along an edge of the insert, called the overmolding limit, the mold comprising a die and a punch defining the mold cavity and being capable of taking different positions between:
an open position in which the mold cavity is sufficiently open to allow the introduction of the inserts and of the polymer material in the mold, and
a molding position in which the mold cavity is closed and defines the shape of the part to be obtained,
as well as closed filling positions in which the mold cavity is closed but has not yet reached the molding position and the polymer material flows into the cavity to fill it,

said mold comprising at least one blocking area carried by the punch and at least one blocking area carried by the die to immobilize at least one metal insert between said blocking areas when the mold is in its closed filling positions, and in its molding position, said blocking areas having faces opposite each other,
the mold comprising at least one movable part capable of sliding with reduced gap with respect to at least one component of the assembly composed of the die and the punch,

wherein it comprises, on one of the opposite faces of the blocking areas, at least one projection which is arranged to exert on the insert, when the mold is in its closed filling positions, and in its molding position, a local stress extending over a sealing area completely including the insert overmolding limit, so as to prevent the polymer material flowing in the cavity from crossing the sealing area and from seeping between the part of the insert intended to not be covered and one of the opposite faces of the blocking areas, and in that the reduced gap allowing the movable part to slide communicates with the mold cavity and forms a vent adapted to allow gases and small quantities of polymer material flowing under pressure in said cavity to escape from the mold cavity.

To avoid any misunderstanding, it is pointed out that “prevent the polymer material . . . from seeping between the part of the insert intended to not be covered and one of the faces” means “prevent the polymer material . . . from seeping between the insert and one face or between the insert and the other face”. In other words, no seepage is possible on a side of the part of the insert intended to not be covered, whatever side of the insert is considered.

According to the invention, the expression “prevent the polymer material flowing in the cavity from crossing the sealing area”, means creating a barrier holding back the polymer material under normal conditions of manufacture of the motor vehicle part. This does not exclude that leaks may occur occasionally when the molding conditions are changed or if the wearing of parts causes leaks, but such leaks must remain exceptional and not correspond to normal mold use conditions. In addition, it does not exclude leaks at the connections of the metal inserts, especially if they overlap partially.

The expression “local stress extending over a sealing area completely including the insert overmolding limit” means that the insert is subjected to pressure over a region which occupies a portion of its width (hence the qualifier “local”) and extends continuously over its entire length, so that there is no place, over the entire length of the overmolding limit, where there would be no pressure and polymer material flowing under pressure in the mold would be able to escape. According to the invention, this feature does not require that the blocking areas need to be in continuous contact with the insert.

According to the definition of the open molding and closed filling positions, it is understood that the mold according to the invention is designed so that its cavity is filled by flow of the polymer material in a mold whose cavity is first closed, but with a volume greater than that of the part to be manufactured (filling closed positions), then reduced to the dimensions of the part to be manufactured (molding position).

Advantageously, the movable part of the mold can slide in the mold closing direction.

Preferably, the reduced gap allowing the movable part to slide with respect to at least one component of the assembly composed of the die and the punch is 0.05 mm.

In a first embodiment of the invention, the movable part is at least one movable block having a blocking area, said block being mounted on or attached to a movable frame carried by the punch and surrounding said punch with reduced gap. The movable block is used to immobilize the inserts before closing the mold, in other words reaching the closed filling positions and, even more, the molding position. The inserts are therefore immobilized in their final position before the polymer material is pressurized to fill the mold cavity completely and partially cover the inserts. In this embodiment, the vent formed by the reduced gap is located between the movable frame and the punch.

In a second embodiment, the movable part of the mold is at least one movable core of the punch and/or of the die, which can either be retracted to give the cavity a volume greater than that of the part to be manufactured or advanced to give the mold cavity the dimensions of the part to be obtained. The movable core is used to pressurize the polymer material and cause it to flow after closing the mold, in other words as soon as the mold is in the closed filling position, so as to completely fill the mold cavity until the molding position is reached.

Thanks to the invention, no burrs of polymer material can be formed on the uncovered portions of the inserts, since the vent(s) do not communicate with the uncovered portions of the inserts. These inserts are therefore ready to serve welding areas during manufacture of the body in white and undergo the subsequent cataphoresis treatment.

Thanks to the invention, a vent cannot form between the inserts and either one of the opposite faces of the mold blocking areas. The gases contained in the cavity, as well as possible small quantities of polymer material flowing in the cavity and forming burrs on the part, are therefore forced out of the cavity through the vent(s) formed by the reduced gap allowing the movable part to slide, vents which open into the cavity away from the parts of the inserts located between the blocking areas.

The burrs present on the molded part resulting from introduction of the polymer material in the mold vents can therefore be removed easily by mechanical or chemical action, without risk of damaging the inserts, since they are separated from the inserts. This removal operation is even easier to achieve if the burrs are perpendicular to the general plane of the molded part.

In a special embodiment, both opposite faces of the blocking areas comprise at least one projection. The insert is then clamped between two projections, which may be opposite each other or offset, depending on the thickness of the insert.

In a special embodiment, the projection(s) of the opposite faces of the blocking areas are peripheral to the mold cavity.

In a special embodiment, the tops of the projection(s) are at constant height in the mold closing direction.

In another embodiment, only one of the opposite faces of the blocking areas has a projection. Opposite this projection, the insert is compressed against the other face which does not have a projection. However, the reaction of this face on the insert is sufficient to create a continuous local stress producing the desired result, in other words create a barrier for the polymer material flowing in the cavity during molding.

The invention also relates to a method for manufacturing a motor vehicle part. This method is wherein it comprises at least one molding step using a mold as defined above.

A part obtained by this method is easily recognizable by the sharpness of the overmolding limit, which interrupts the plastic material front on the uncovered portions of the metal inserts and, especially, through the mark left by the projection on these inserts.

The invention also relates to a motor vehicle part, wherein it is manufactured according to the method described above.

In a special embodiment, the part is made of a thermosetting material such AMC (Advanced Molding Compound), BMC (Bulk Molding Compound or SMC (Sheet Molding Compound) or a thermoplastic material, more especially one based on polyamide (PA) or polypropylene (PP).

The invention also relates to a motor vehicle floor manufactured according to the method described above.

These and other objects and advantages of the invention will be apparent from the following description, the accompanying drawings and the appended claims.

### BRIEF DESCRIPTION OF THE ACCOMPANYING DRAWINGS

It will be easier to understand the invention on reading the attached figures, which are given purely by way of example and are not to be construed as limiting, in which:

FIGS. 1A-1F are a set of six drawings showing a mold in an implementation of the method according to the invention;

FIG. 2 is a perspective view of a lateral insert of a floor shown in FIG. 9;

FIG. 3 is a perspective view of a front insert of the floor shown in FIG. 9;

FIG. 4 is a perspective view of a rear insert of the floor shown in FIG. 9;

FIG. 5 is a sectional view of part of the mold;

FIG. 6 is a perspective view of a central insert positionable in the mold;

FIG. 7 is a sectional view of a part of the mold;

FIG. 8 is a local enlargement of area VIII in FIG. 7;

FIG. 9 is a perspective view of a floor obtained by molding using the elements of the preceding figures;

FIGS. 10A-10C are a set of three variants of cross-sections of a projection of an insert; and

FIGS. 11A-11F are a set of six drawings showing a mold in another implementation of the method according to the invention.

### DETAILED DESCRIPTION OF THE PREFERRED EMBODIMENTS

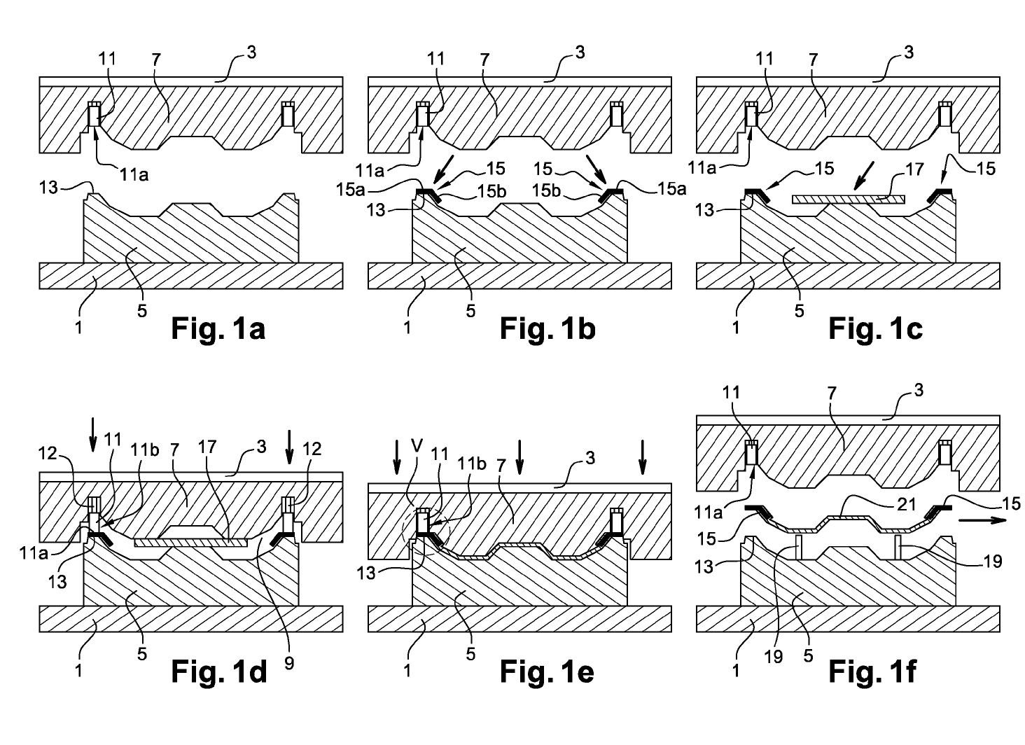

We now refer to FIGS. 1A-1F representing a two-part mold during six successive steps of a method for manufacturing a part made of polymer material.

The mold is mounted on a press (not shown) having a fixed platen 1 and a movable platen 3.

The mold comprises a die 5 which is mounted on the fixed platen 1 of the press, and a punch 7, mounted on the movable platen 3.

The mold is of the compression chamber type, which means that during its closing movement from its open position (FIGS. 1A, 1B and 1C), there comes a point where the mold cavity is a closed space 9, as shown in FIG. 1D. At this time, the mold is in a closed filling position. The volume of the closed space 9 is of course greater than that of the mold cavity, which is defined when the mold has reached the molding position, and which corresponds to the finished part. During all the closed filling positions and until the molding position (FIG. 1E), the punch 7 slides like a piston along a surface defining a compression chamber. The sealing of the mold with respect to the material flowing in the mold to produce the finished part is in principle provided at the compression chamber.

In the case of the mold of FIGS. 1A-1F, the surface delimiting the compression chamber is created by a peripheral movable block 11, which can take a retracted position (FIG. 1A) in the movable platen 3 of the press and an advanced position (FIG. 1D). This movable block 11, which, although drawn as a single piece may consist of several pieces, performs two functions.

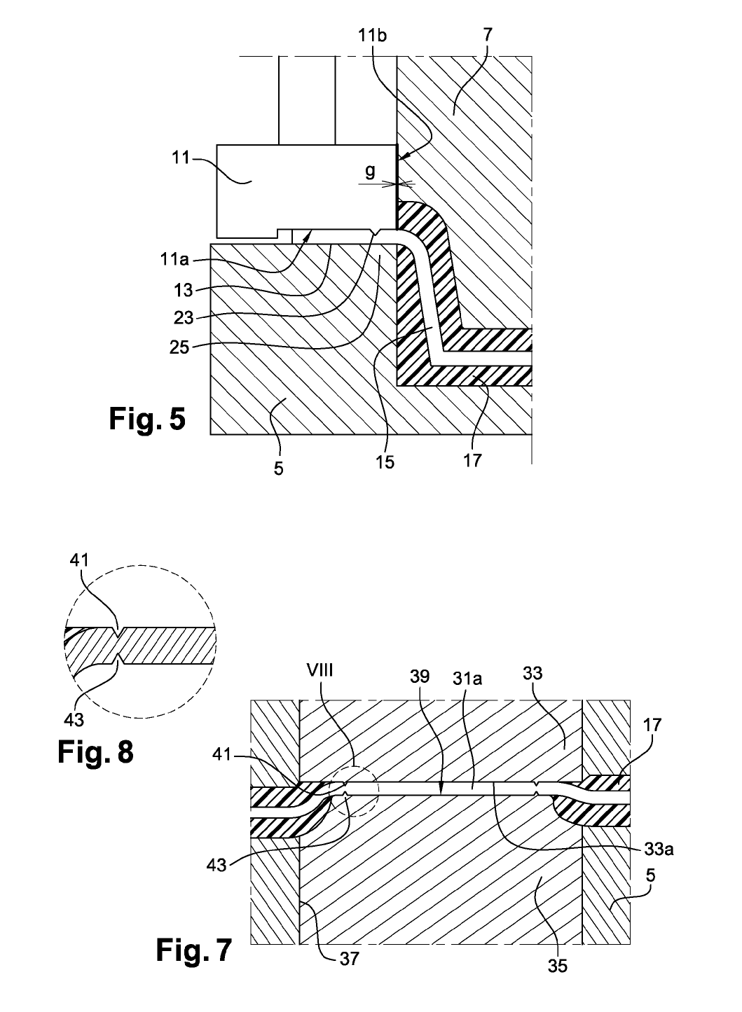

Firstly, by its inner face 11b, it forms the above-mentioned surface against which the punch 7 slides. A gap g of 0.05 mm (see FIG. 5) is therefore left between the inner surface 11b of the movable block 11 and the punch 7. This gap g also acts as a vent, allowing gases trapped in the cavity to escape while the mold is being filled with the polymer material.

Secondly, by its lower face 11a, the movable block 11 forms, with a blocking area having a face or blocking area 13 provided on the die 5, opposite the face 11a of movable block 11, a means of blocking one or more inserts which will be described later. The movable block 11 is made in a single piece with a frame which is mounted on jacks 12 carried by the punch 7 in order to move up to the blocking area 13 before the punch 7 engages by sliding in the compression chamber. In a variant not shown, the movable block 11 is a part separate from the frame, mounted on the lower side of the frame.

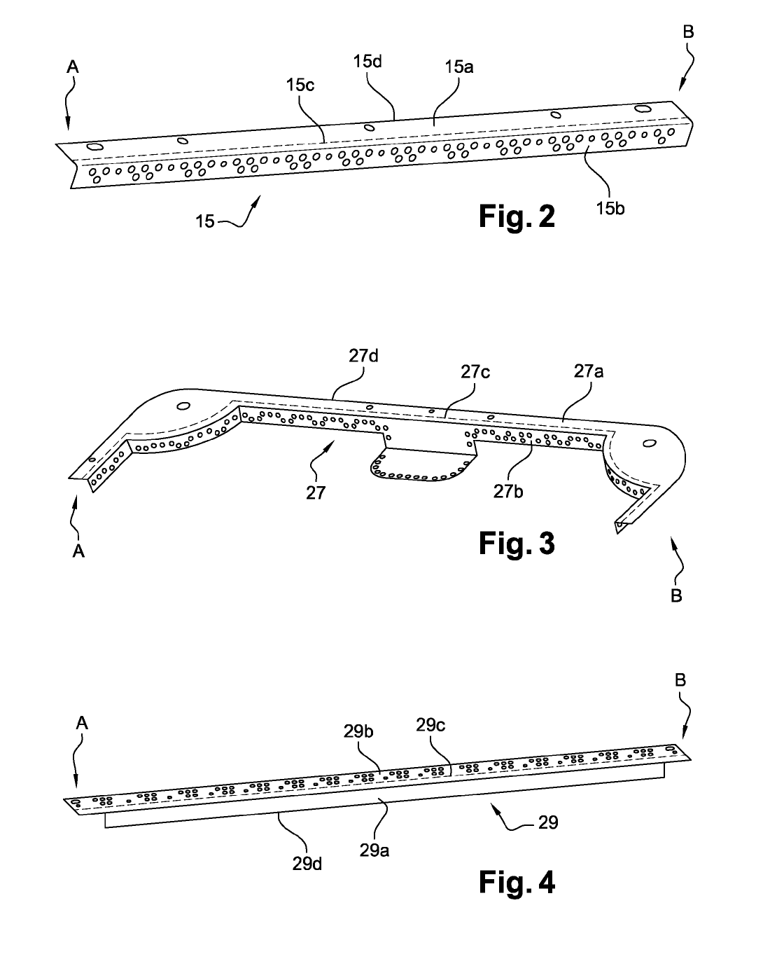

The perspective views of FIGS. 2, 3 and 4 show, respectively, lateral 15, front 29 and rear 27 metal inserts, which are adapted to be placed in the mold in open position. Each insert has an elongated shape which is rectilinear for the lateral insert 15 of FIG. 2 and non-rectilinear for the front 27 and rear 29 inserts of FIGS. 3 and 4.

FIGS. 3 and 4 show that each of the front 27 and rear 29 inserts comprises an uncovered portion 27a, 29a which is intended to be clamped by the movable block 11 against the blocking area 13 of the die 5 and a portion 27b, 29b which is intended to be overmolded by the plastic material.

Each of the inserts 15, 27 and 29 have special contours and holes which are specific to the floor model to be obtained. Similarly, each insert 15, 27 and 29 has a transverse cross-section bent at a special angle which may be different from one insert to another or from one location to another over the length of a given insert. These shape characteristics of the inserts 15, 27 and 29 will not be described in detail in this description.

As shown FIG. 1B, the lateral insert 15 is positioned on the die 5 so that a portion 15a of the insert covers the face of the blocking area 13 and so that a portion 15b of the insert is housed in the mold cavity. The portion 15b housed in the mold cavity is a part of the lateral insert 15 which is intended to be overmolded while the portion 15a covering the face of the blocking area 13 is a part which is intended to protrude from the molded part. This latter portion 15a of the lateral insert 15 will be designated the “uncovered portion”. The boundary 15c between portion 15b intended to be overmolded and uncovered portion 15a, called the overmolding limit, is an imaginary line schematized by a dashed line on FIG. 2. The same overmolding limit 27c exists between parts 27a and 27b of the front insert 27. The same applies with the overmolding limit 29c of the rear insert 29.

The overmolding limits 15c, 27c and 29c extend from a first end A of each insert to an opposite end B of the insert 15, 27 and 29, without leaving the insert 15, 27 and 29 and following approximately its edge 15d, 27d, 29d which is not necessarily rectilinear.

The material used for molding is a thermosetting plastic of type SMC (sheet molding compound). It is deposited in the open mold, on the die 5, substantially in the middle of the cavity although this is not a necessity, as a blank SMC sheet 17, as is known. The step of depositing the material in the mold in open position is illustrated by FIG. 1C.

Referring to FIGS. 1A-1F, we will now describe six successive steps of the molding method according to the invention.

In a first step, illustrated by FIG. 1A, the mold is in open position: the punch 7 is far away from the die 5 and the movable block 11 is retracted in the punch 7.

In a second step, illustrated by FIG. 1B, the front 27, lateral 15 and rear 29 inserts are positioned on the blocking area 13 of the die 5.

In a third step, illustrated by FIG. 1C, an SMC sheet 17 is deposited in the middle of the cavity, on the die 5. The second and third steps may be combined or performed in a different order.

In a fourth step, not shown, the movable part 3 is brought close to the fixed part 1, but without closing the mold, in other words without any of the parts of the upper half of the mold, namely the punch 7 and the movable block 11, touching one of the parts of the lower half of the mold, namely the die 5. The mold has therefore not yet reached its closed filling positions.

In a fifth step, the jacks 12 are then actuated to lower the movable block 11 toward the blocking area 13 of the die, as illustrated by FIG. 1D. In so doing, face 11a of the movable block 11 moves against the uncovered portions 15a of the front, lateral 15 and rear inserts, firmly blocking them in position against face 13 of the blocking area.

Thus positioned, the movable block 11 performs its two functions: firstly, it holds the inserts in position ready to fill the mold cavity by flowing of the material 17, and secondly it forms a compression chamber. The mold cavity, delimited by the punch 7, the movable block 11 and the die 5, is therefore closed, but does not yet define the shape of the part to be obtained. The mold is in closed filling position.

In a sixth step, illustrated by FIG. 1E, the movable part 3 of the press continues its path towards the fixed part 1. In so doing, the punch 7 continues its movement by sliding like a piston in the movable block 11. The movable block 11 remains stationary resting against the inserts 15, while the jacks 12 move back without reducing the pressure holding the inserts 15. The inner face 11b of the movable block 11 forms the lateral wall of the compression chamber against which the punch 7 slides. Due to the reduction in cavity volume and the molten state of the polymer material, the material 17 flows into the mold cavity filling it completely, in particular covering parts 15b of the inserts 15 which are housed in the mold cavity. When the punch 7 has finished its movement, the mold is in molding position. The volume of the cavity between the punch 7, the movable block 11 and the die 5 is that of the finished part.

In a seventh step, illustrated by FIG. 1F, the movable part 3 of the press starts to move in the mold opening direction. This time the movable block 11 remains fastened to the punch 7 and rises up with it, thereby returning the mold to the fully open position. Ejectors 19, provided in the die 5, raise the molded part 21. The latter is then released and the ejectors 19 retracted, in order to start a molding cycle from the step illustrated by FIG. 1A.

We will now return to the description of the fourth and fifth steps above, in reference to FIG. 5. FIG. 5 is a detailed view of part V of the drawing of FIG. 1E. It shows the inner face 11b of the movable block 11, which forms a sliding surface for the punch 7 by providing a gap g. It also shows that the lower face 11a has a projection 23 which bites into the insert 15. This projection 23 is arranged to create continuous local stress on the insert 15 along its entire length. In the embodiment described, the projection 23 is a V-shaped rib which, in the example described, extends continuously over the entire face 11a of the movable block 11. In another example (not shown), the V-shaped rib or projection 23 may not be continuous but could generate continuous stress.

More precisely, the projection 23 has an opening angle of 90° and a height of 0.2 mm from the surface 11a. These quantities are especially suitable for inserts made of a 0.67 mm overmolded sheet with a bodywork steel of type DC04+ZE according to standard NF EN 10152 (XES quality index according to the former standard NF 36-401).

Other shapes are also possible for the projection 23, both as regards the cross-section of the projection 23 and its arrangement on face 11a of the movable block 11. For example, studs distributed regularly on face 11a and creating continuous stress on the entire length of the insert 15 could be used. This projection 23 could have a V-shaped or other cross-section, such as trapezoidal or rounded, illustrated in FIG. 10. The projection 23 may also be combined with a second parallel projection 23′. For example, the width of a round projection 23 may be between 0.4 mm and 0.8 mm with a height of 0.2 mm.

The local stress created by the projection 23 spreads in the insert 15 throughout a region 25 around the area bitten by the projection 23. In particular, the local stress increases the pressure between the insert 15 and the movable block 11 and also between the insert 15 and the face of the blocking area 13 of the die 5.

Consequently, the joints formed firstly between the insert 15 and the movable block 11 and secondly between the insert 15 and the blocking area 13 form a seal against gases and the polymer material flowing under pressure in the mold. A sealed area is therefore created between the insert 15 and one of the opposite faces of the block 11 and of the blocking area 13.

However, the 0.05 mm gap g between the punch 7 and the inner face 11b of the movable block 11, which forms a vent for the mold, allows the gases and the polymer material flowing under pressure in the cavity to escape.

Consequently, if gas must escape in the region of the movable block 11, it can only occur between the punch 7 and the inner face 11b of the movable block 11 and not between the insert 15 and the movable block 11, nor between the insert 15 and the face of the blocking area 13 of the die 5.

In other words, the 0.05 mm gap between the punch 7 and the inner face 11b of the movable block 11 forms a vent opening out into the cavity and allowing, when the mold is closed, the gases contained in the cavity to escape. But thanks to the projection 23, no vent can form in the uncovered portion 15a of the insert 15.

Given the high fluidity of the thermosetting plastic material while it flows in the mold, the vents provided to allow gas to escape frequently also allow the liquid plastic material to flow out. These flows of plastic material, after cooling and reticulation of the material, form burrs which must be removed.

Thanks to the invention, the burrs can only form in the mold vent(s). They are therefore clearly separated from the uncovered portions 15a of the inserts 15 and there is no risk of damaging the inserts 15 when removing them by trimming.

Furthermore, given the orientation of the vent, which is perpendicular to the uncovered portions 15a, 27a, 29a of the inserts 15, 27 and 29, the burrs which may form on the part are films of material extending perpendicularly to the uncovered portions of the inserts 15, 27 and 29. Consequently, these films are very easy to access, which facilitates their separation from the part, by any known trimming technique.

According to the invention, it is important that each insert 15, 27 and 29 comprises two parts:

one, intended to remain uncovered, which will be clamped by the movable block 11, and
the other, intended to be overmolded by the plastic material, with an overmolding limit between the two parts.

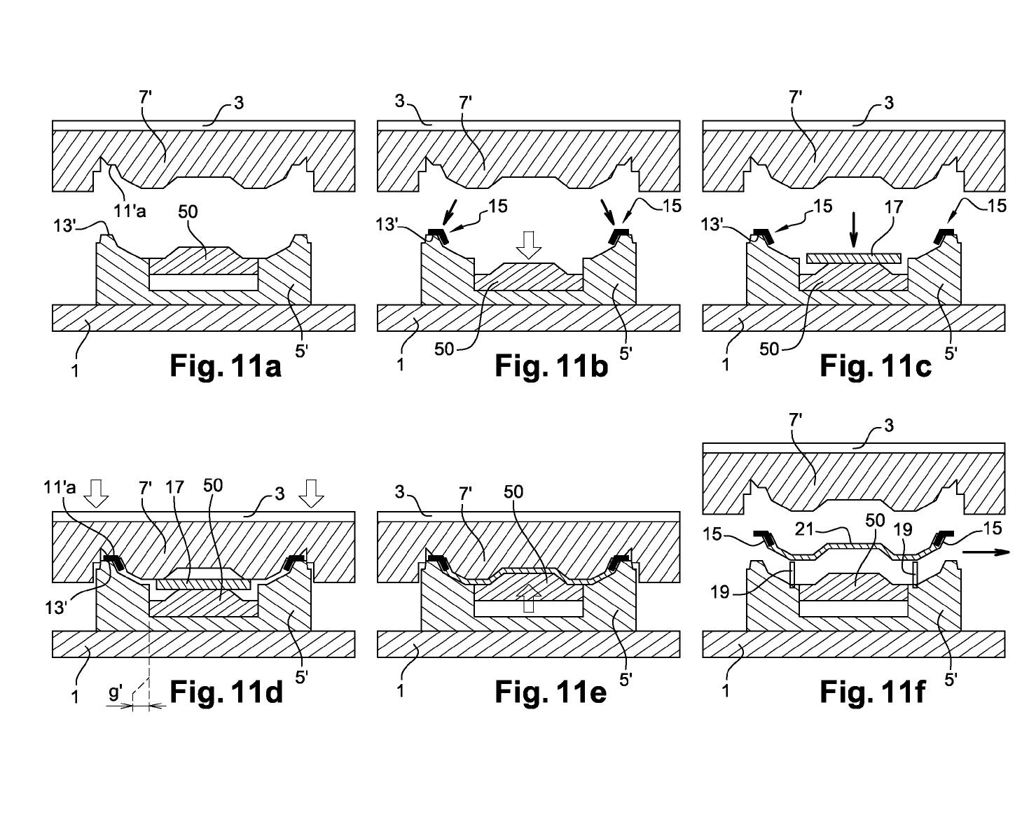

In the embodiment of FIG. 11, the movable part of the mold is at least one movable core 50 of the punch 7 and/or of the die 5, which can either be retracted to give the cavity a volume greater than that of the part to be manufactured or advanced to give the mold cavity the dimensions of the part to be obtained.

Thus, in contrast with the previous embodiment, the block 11 is not movable, but in this case the die 5′ has in its central portion, a core 50 movable between two positions, namely:
a retracted position in which it releases, in the mold cavity, an additional volume capable of accommodating the sheet of plastic material 17, so that the sheet 17 does not occupy the entire volume of the mold cavity, and
a flush position in which the core occupies this extra volume,

a 0.05 mm gap g′ is created between the core 50 and the die 5′ forming a vent allowing gases trapped in the cavity to escape while the mold is being filled with the polymer material.

A blocking area is formed by a shoulder 11a′ of the punch 7′ and another blocking area 13′ is the same as on the die of FIGS. 1A-1F.

The steps of FIGS. 1A, 1B and 1C are carried out first, as already explained in reference to FIGS. 1A-1F. In FIG. 1A, the movable core 50 is in flush position. It is placed in the retracted position in FIG. 1B then the SMC sheet 17 is deposited in FIG. 1C. The order of FIGS. 1A, 1B and 1C may be different without departing from the scope of the invention. The mold is then closed while the core 50 is in the retracted position, as illustrated by FIG. 1D. The only effect of this closure is to bring the blocking area 11a′ up against the inserts 15 in order to immobilize them in position.

The polymer material flows and fills the mold cavity due to the movement of the movable core 50 into flush position, as illustrated by FIG. 1E. The gases trapped in the cavity must then escape through vents. One of these vents is the gap g′ formed between the movable core 50 and the die 5′. As in the previous embodiment, the vents are separated from the contact surfaces between the inserts and, firstly the blocking area 11a′ and secondly the other blocking area 13′ of the die 5′, so that any burrs of material resulting from a flow of polymer material in the vent occur at places far away from the inserts 15, 27 and 29.

In addition, since the vent orientation is perpendicular to the general plane, the burrs are easy to remove.

As in the previous embodiment, the cycle ends with the mold opening and ejection of the part. Molding of a new part can start, from FIG. 1A.

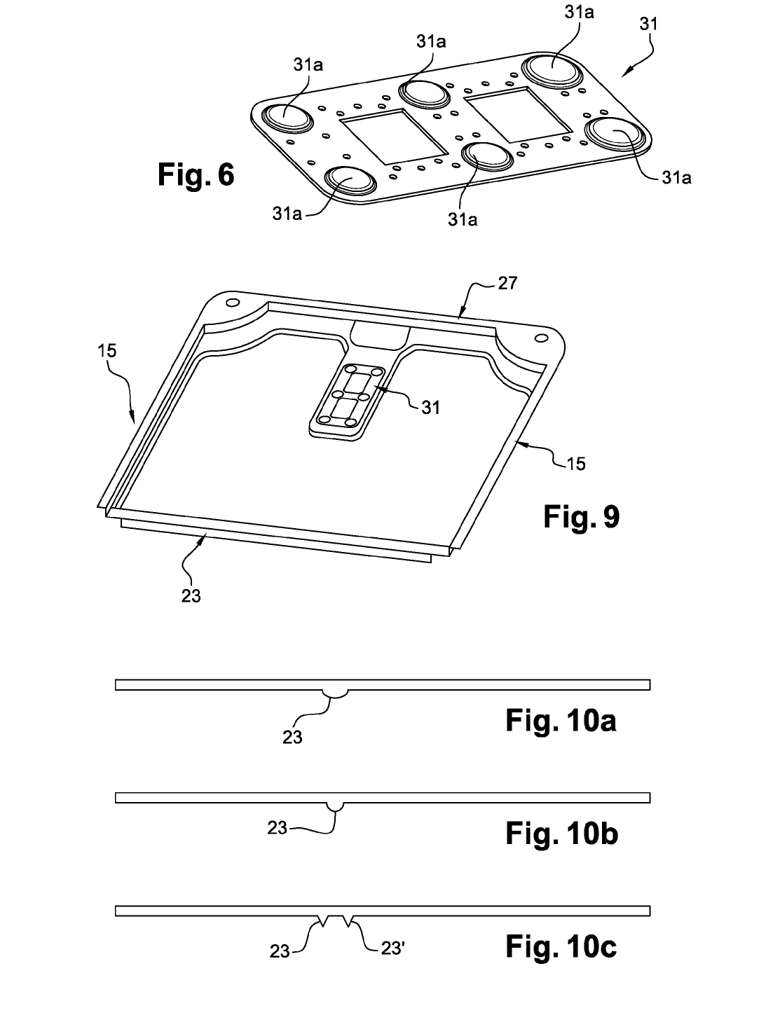

FIG. 6 shows a central insert 31 which is planned to be deposited inside the mold, in the middle of the die 5 of FIGS. 1A-1F and which is therefore not on the periphery of the finished part.

This insert 31 consists of six parts 31a which must not be covered by the polymer material during overmolding and parts 31b intended to be overmolded, in other words embedded in the plastic material during overmolding.

To overmolded this insert 31, as shown in the sectional view of FIG. 7, movable blocks 33 mounted, like movable block 11, on jacks (not shown) are added to the mold punch 7 described previously. Each movable block 33 has a lower face 33a forming a blocking area designed to accommodate the upper side of a part 31a of the central insert 31. On the die 5, studs 35 are added opposite the movable blocks 33 of the punch 7. The studs 35 are forced into holes 37 made in the die 5. The fact that the die 5 and the studs 35 are separate parts is only justified to simplify manufacturing, development and maintenance, but has no direct link with the method of the invention. We will consider that the studs 35 are an integral part of the die 5.

Each stud 35 has an upper face 39 forming a blocking area designed to accommodate the lower side of a part 31 a of the central insert 31.

As seen in FIG. 7, the lower face 33a of each movable block 33 and the upper face 39 of each stud 35 are each provided with a circumferential projection 41, respectively 43. The projections 41 and 43 are opposite each other. In a variant not shown, the projections 41 and 43 are offset with respect to each other. These two arrangements will be chosen depending, in particular, on the thickness of the insert and the type of steel from which it is made, in order to not to cut through it when closing the mold.

In the example described on this FIG. 7, the projections 41 and 43 are V-shaped with an opening angle of 120° and a height of 0.2 mm.

Thanks to the projections 41 and 43, a sealed area is created between the insert and one of the opposite faces of the block and of the blocking area, sealed area beyond which the polymer material does not seep.

The overmolding of the central insert 31 takes place in a mold further comprising vents which, as previously explained, are formed by a movable part of the mold far away from the inserts.

As previously, the uncovered areas 31a of the central insert are particularly sharp and contain no burrs of plastic material.

FIG. 9 shows in perspective the part obtained by molding comprising the front, lateral, rear and central inserts described previously.

In a special embodiment, the part obtained may be a floor. As an indication, such a floor has a length of 1000 mm, a width of 800 mm and a variable depth which is less than 100 mm, for so-called flat floors, and a depth of 400 mm for floors adapted to receive a spare wheel or other large component such as a battery, for example.

We see that each insert has its parts 15a, 27a, 29a, 31a uncovered, in other words not overmolded, cleanly delimited by the projections 23, 41 and 43. Any burrs which were formed on the part during molding are limited to the periphery of the part and extend perpendicular to the inserts, since they come from the joint plane formed by the inner face 11b of the movable block 11.

The invention is not limited to the embodiments described and other embodiments will be clearly apparent to those skilled in the art. In particular, the shape of the projections 23, 41, 43 may be different provided that the basic invention remains unchanged.

While the system, apparatus, process and method herein described constitute preferred embodiments of this invention, it is to be understood that the invention is not limited to this precise system, apparatus, process and method, and that changes may be made therein without departing from the scope of the invention which is defined in the appended claims.

What is claimed is:

1. A mold for forming a motor vehicle part from a polymer material comprising at least a partially overmolded metal insert, in other words having a portion intended to be covered with polymer material and a portion intended to be left uncovered, the limit between these two portions being a line along an edge of the insert, called the overmolding limit, the mold comprising a die and a punch defining a mold cavity and being capable of taking different positions between:
an open position in which the mold cavity is sufficiently open to allow the introduction of the inserts and of the polymer material in the mold; and
a molding position in which the mold cavity is closed and defines the shape of the part to be obtained;
as well as closed filling positions in which the mold cavity is closed but has not yet reached the molding position and the polymer material flows into the mold cavity to fill it;
said mold comprising at least one blocking area carried by the punch and at least one blocking area carried by the die to immobilize at least one metal insert between said blocking areas when the mold is in its closed filling positions, and in its molding position, said blocking areas having opposite faces;
the mold comprising at least one movable part capable of sliding with reduced gap with respect to at least one component of the assembly composed of the die and the punch;
wherein the mold comprises, on one of the opposite faces of the blocking areas, at least one projection which is arranged to exert on the insert, when the mold is in its closed filling positions, and in its molding position, a local stress extending over a sealing area completely including the insert overmolding limit, so as to prevent the polymer material flowing in the cavity from crossing the sealing area and from seeping between the part of the insert intended to not be covered and one of the opposite faces of the blocking areas, and in that the reduced gap allowing the movable part to slide communicates with the mold cavity and forms a vent adapted to allow gases and small quantities of polymer material flowing under pressure in said cavity to escape from the mold cavity.

2. The mold according to claim 1, whose at least one movable part can slide in the mold closing direction.

3. The mold according to claim 1, wherein the reduced gap allowing the at least one movable part to slide with respect to at least one component of the assembly composed of the die and the punch is about 0.05 mm.

4. The mold according to claim 1, wherein the at least one movable part is at least one movable block having a blocking area, said at least one movable block being attached to or formed in a single piece with a movable frame carried by the punch and surrounding said punch with reduced gap.

5. The mold according to claim 1, wherein the at least one movable part is at least one movable core of the punch and/or of the die, which can either be retracted to give the cavity a volume greater than that of the part to be manufactured or advanced to give the mold cavity the dimensions of the part to be obtained.

6. The mold according to claim 1, wherein both opposite faces of the blocking areas comprise at least one projection.

7. The mold according to claim 1, wherein the projection(s) of the opposite sides of the blocking areas are peripheral to the mold cavity.

8. The mold according to claim 1, wherein the tops of the projection(s) are at constant height in the mold closing direction.

9. The mold according to claim 1, wherein only one of the opposite faces of the blocking areas has a projection.

10. A method for manufacturing a motor vehicle part, wherein said method comprises at least one molding step using a mold for forming a motor vehicle part from a polymer material comprising at least a partially overmolded metal insert, in other words having a portion intended to be covered with polymer material and a portion intended to be left uncovered, the intended to be covered with polymer material and a portion intended to be left uncovered, the limit between these two portions being a line along an edge of the insert, called the overmolding limit, the mold comprising a die and a punch defining a mold cavity and being capable of taking different positions between;
an open position in which the mold cavity is sufficiently open to allow the introduction of the inserts and of the polymer material in the mold; and
a molding position in which the mold cavity is closed and defines the shape of the part to be obtained;
as well as closed filling position in which the mold cavity is closed but has not yet reached the molding position and the polymer material flows into the mold cavity to fill it;
said mold comprising at least one blocking area carried by the punch and at least one blocking area carried by the die to immobilize at least one medal insert between said blocking areas when the mold is in its closed filling positions, and in its molding position, said blocking areas having opposite faces;
the mold comprising at least one movable part capable of sliding with reduced gap with respect to at least one component of the assembly composed of the die and the punch;
wherein the mold comprises, on one of the opposite faces of the blocking areas, at least one projection which is arranged to exert on the insert, when the mold is in its closed filling positions, and in its molding position, a local stress extending over a sealing area completely including the insert over molding limit, so as to prevent the polymer material flowing in the cavity from crossing the sealing area and from seeping between the part of the insert intended to not be covered and one of the opposite faces of the blocking areas, and in that the reduced gap allowing the movable part to slide communicates with the mold cavity and forms a vent adapted to allow gases and small quantities of polymer material flowing under pressure in said cavity to escape from the mold cavity.

11. A motor vehicle part, that is manufactured according to the method of claim 10.

12. The motor vehicle part according to claim 11, made of a thermosetting material such as AMC (Advanced Molding Compound), BMC (Bulk Molding Compound) or SMC (Sheet Molding Compound) or a thermoplastic material, more especially one based on polyamide (PA) or polycarbonate (PC).

13. A motor vehicle floor, that it is made according to the method of claim 10.

14. The mold according to claim 2, wherein the reduced gap allowing the at least one movable part to slide with respect to at least one component of the assembly composed of the die and the punch is about 0.05 mm.

15. The mold according to claim 2, wherein the at least one movable part is at least one movable block having a blocking area, said at least one movable block being attached to or formed in a single piece with a movable frame carried by the punch and surrounding said punch with reduced gap.

16. The mold according to claim 3, wherein the at least one movable part is at least one movable block having a blocking area, said at least one movable block being attached to or formed in a single piece with a movable frame carried by the punch and surrounding said punch with reduced gap.

17. The mold according to claim 2, wherein the at least one movable part is at least one movable core of the punch and/or of the die, which can either be retracted to give the cavity a volume greater than that of the part to be manufactured or advanced to give the mold cavity the dimensions of the part to be obtained.

18. The mold according to claim 3, wherein the at least one movable part is at least one movable core of the punch and/or of the die, which can either be retracted to give the cavity a volume greater than that of the part to be manufactured or advanced to give the mold cavity the dimensions of the part to be obtained.

19. The mold according to claim 2, wherein both opposite faces of the blocking areas comprise at least one projection.

20. The mold according to claim 2, wherein the projection(s) of the opposite sides of the blocking areas are peripheral to the mold cavity.

21. The mold according to claim 1, wherein said motor vehicle part is a motor vehicle floor.
